(19) United States
(12) Patent Application Publication
(10) Pub. No.: US 2025/0220473 A1
(43) Pub. Date: Jul. 3, 2025

(54) LINK MONITORING METHOD AND APPARATUS, AND TERMINAL

(71) Applicant: VIVO MOBILE COMMUNICATION CO., LTD., Guangdong (CN)

(72) Inventors: Dajie JIANG, Guangdong (CN); Wei BAO, Guangdong (CN); Xueming PAN, Guangdong (CN)

(73) Assignee: VIVO MOBILE COMMUNICATION CO., LTD., Guangdong (CN)

(21) Appl. No.: 19/084,195

(22) Filed: Mar. 19, 2025

Related U.S. Application Data
(63) Continuation of application No. PCT/CN2023/118444, filed on Sep. 13, 2023.

(30) Foreign Application Priority Data
Sep. 20, 2022 (CN) 202211146463.X

(51) Int. Cl. H04W 24/08; H04B 17/309; H04L 5/00; H04W 76/30

(52) U.S. Cl. CPC H04W 24/08; H04B 17/309; H04L 5/0048; H04W 76/30

(57) ABSTRACT

A link monitoring method and apparatus, and a terminal, and relates to the field of integrated sensing and communication technologies. The link monitoring method in the embodiments of this application includes: A terminal detects a target signal. The terminal performs a measurement based on the target signal, and obtains link performance corresponding to the target signal, where the target signal includes a first signal, or the target signal includes a first signal and a second signal, and the first signal is a reference signal or a sensing signal; and the link performance includes sensing link performance, or the link performance includes sensing link performance and communication link performance.

### CROSS-REFERENCE TO RELATED APPLICATIONS

This application is a continuation of PCT Application No. PCT/CN2023/118444 filed on Sep. 13, 2023, which claims priority to Chinese Patent Application No. 202211146463.X filed on Sep. 20, 2022, which are incorporated herein by reference in their entireties.

### TECHNICAL FIELD

This application relates to the field of integrated sensing and communication technologies, and specifically, to a link monitoring method and apparatus, and a terminal.

### BACKGROUND

A radio link monitoring (RLM) procedure mainly includes:
1. A physical layer performs, every indication period, one measurement on at least one radio link monitoring reference signal (RLM-RS) configured by a base station, to evaluate received block error rate (BLER) performance of a corresponding physical downlink control channel (PDCCH).

The RLM-RS may be a synchronization signal and PBCH block (SSB) signal, a channel state information reference signal (CSI-RS), or a combination thereof.
2. In a case that the BLER performance is lower than a target BLER threshold, such as 2%, the physical layer reports in-sync (IS) to a higher layer (radio resource control (RRC) layer).

The IS is reported provided that one reference signal (RS) meets a condition.
3. In a case that the BLER performance is higher than the target BLER threshold, such as 10%, the physical layer reports out-of-sync (OOS) to the higher layer.

The OOS is reported only when all RSs meet the condition.
4. In a case that a quantity of OOS continuously reported exceeds a threshold N310, a T310 timer is started.
5. In a case that a quantity of IS continuously reported during running of the T310 timer reaches a specific threshold N311, the T310 timer is stopped (an RRC connection is still maintained in this case).
6. Otherwise, RRC declares a radio link failure (RLF), and RRC reestablishment is performed.

However, the current radio link monitoring procedure is not applicable to an integrated sensing and communication scenario.

### SUMMARY

According to a first aspect, a link monitoring method is provided, and includes:

A terminal detects a target signal.

The terminal performs a measurement based on the target signal, and obtains link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

According to a second aspect, a link monitoring apparatus is provided, and includes:
a detection module, configured to detect a target signal; and
an obtaining module, configured to perform a measurement based on the target signal, and obtain link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

According to a third aspect, a terminal is provided. The terminal includes a processor and a memory, the memory stores a program or an instruction that is executable on the processor, and the program or the instruction is executed by the processor to implement the steps of the method according to the first aspect.

According to a fourth aspect, a terminal is provided, and includes a processor and a communication interface. The communication interface is configured to detect a target signal; and perform a measurement based on the target signal, and obtain link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

According to a fifth aspect, a link monitoring system is provided, and includes a terminal and a network side device. The terminal may be configured to perform the steps of the link monitoring method according to the first aspect.

According to a sixth aspect, a readable storage medium is provided. The readable storage medium stores a program or an instruction, and the program or the instruction is executed by a processor to implement the steps of the method according to the first aspect.

According to a seventh aspect, a chip is provided. The chip includes a processor and a communication interface, the communication interface is coupled to the processor, and the processor is used to run a program or an instruction to implement the method according to the first aspect.

According to an eighth aspect, a computer program/program product is provided. The computer program/program product is stored in a storage medium, and the computer program/program product is executed by at least one processor to implement the steps of the link monitoring method according to the first aspect.

### BRIEF DESCRIPTION OF DRAWINGS

FIG. 1 is a block diagram of a wireless communication system to which embodiments of this application may be applied;

FIG. 2 is a schematic flowchart of a link monitoring method according to an embodiment of this application;

FIG. 3 is a schematic diagram of SNR calculation in one-dimensional graph;

FIG. 4 is a schematic diagram of modules of a link monitoring apparatus according to an embodiment of this application;

FIG. 5 is a schematic diagram of a structure of a terminal according to an embodiment of this application; and

FIG. 6 is a schematic diagram of a structure of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a new radio (NR) system for example purposes, and NR terms are used in most of the following descriptions. These technologies can also be applied to applications other than an NR system application, such as a 6th generation (6G) communication system.

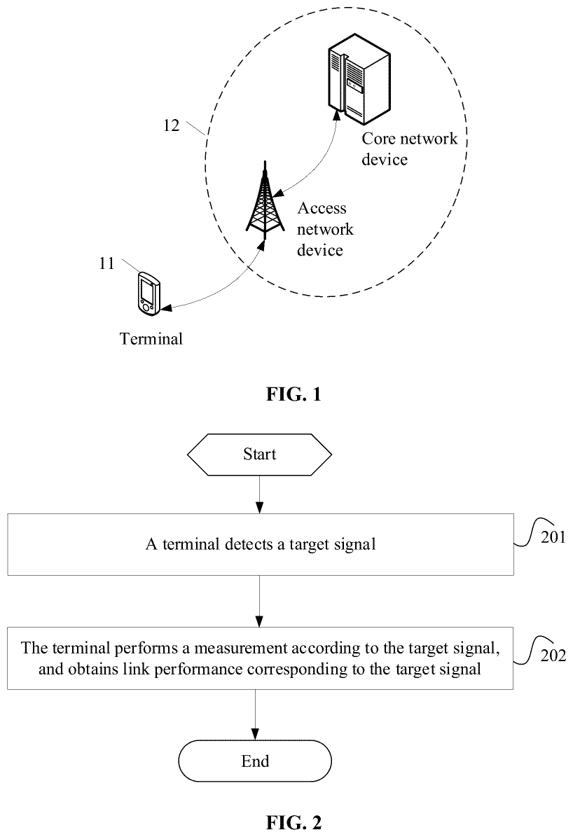

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device and a core network device. The access network device may also be referred to as a radio access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

Related technologies involved in this application are first described as follows:

### 1. Integrated Sensing and Communication

A future mobile communication system such as beyond 5th Generation (B5G) systems or a 6G system has a sensing capability in addition to a communication capability. The sensing capability is that one or more devices with the sensing capability can sense information such as a direction, a distance, and a speed of a target object by sending and receiving a radio signal, or detect, track, identify, or image a target object, an event, an environment, or the like. In the future, with the deployment of a small base station with a capability of a high frequency band and high bandwidth such as millimeter wave and terahertz in a 6G network, resolution of sensing is significantly improved when compared with that of a centimeter wave, so that the 6G network can provide a more precise sensing service. A typical sensing function and an application scenario are shown in Table 1.

TABLE 1
Comparison table for a typical sensing function and an application scenario

| Communication | | |
|---|---|---|
| sensing category | Sensing function | Application scenario |
| Macro sensing type | Weather conditions, air quality, and | Meteorology, agriculture, and |
| | the like | life services |
| | Traffic flow (intersections) and | Intelligent traffic and |
| | flow of people (subway entrances) | commercial services |
| | Target tracking, ranging, speed | Many application scenarios for |
| | measurement, contours, and the | conventional radars |
| | like | |
| | Environment reconstruction | Intelligent driving and navigation |
| | | (car/uncrewed aerial vehicles), |
| | | smart city (three-dimensional |
| | | (3D) map), and network planning |
| | | and optimization |
| Fine sensing type | Action/posture/expression | Intelligent interaction of |
| | recognition | smartphones, games, and smart |
| | | home |
| | Heartbeat/breathing and the like | Health and medical care |
| | Imaging, material detection, | Security inspection, industry, |
| | component analysis, and the like | biological medicine, and the like |

There are six basic sensing manners according to different sending nodes and receiving nodes of a sensing signal, which specifically include:
(1) Base station self-sending and self-receiving sensing. In this sensing manner, a base station A sends a sensing signal and performs sensing measurement by receiving an echo of the sensing signal.
(2) Air interface sensing between base stations. In this case, a base station B receives a sensing signal sent by a base station A, and performs sensing measurement.
(3) Uplink air interface sensing. In this case, a base station A receives a sensing signal sent by a terminal A, and performs sensing measurement.
(4) Downlink air interface sensing. In this case, a terminal B receives a sensing signal sent by a base station B, and performs sensing measurement.
(5) Terminal self-sending and self-receiving sensing. In this case, a terminal A sends a sensing signal and performs sensing measurement by receiving an echo of the sensing signal.
(6) Sidelink sensing between terminals. In this case, a terminal B receives a sensing signal sent by a terminal A, and performs sensing measurement.

It should be noted that in an actual system, one or more different sensing manners may be selected according to different sensing use cases and sensing requirements, and there may be one or more sending nodes and receiving nodes in each sensing manner.

A link monitoring method and apparatus and a terminal provided in the embodiments of this application are described below in detail with reference to the accompanying drawings by using some embodiments and application scenarios thereof.

As shown in FIG. 2, an embodiment of this application provides a link monitoring method, including the following steps:
Step 201: A terminal detects a target signal.
Step 202: The terminal performs a measurement based on the target signal, and obtains link performance corresponding to the target signal.

The target signal includes a first signal, or the target signal includes a first signal and a second signal, and the first signal is a reference signal or a sensing signal.

The link performance includes sensing link performance, or the link performance includes sensing link performance and communication link performance.

Optionally, when sensing measurement is performed on the first signal, sensing link performance corresponding to the first signal may be obtained. When sensing measurement and communication measurement are performed on the first signal, sensing link performance and communication link performance corresponding to the first signal may be obtained. When sensing measurement is performed on the first signal and communication measurement is performed on the second signal, sensing link performance corresponding to the first signal and communication link performance corresponding to the second signal may be obtained.

It should be noted that a sensing service may be supported by receiving the sensing signal, for example, a sensing measurement quantity or a sensing result may be obtained by receiving the signal.

It should be noted that at least one first signal is measured to obtain at least the sensing link performance, so as to implement radio link monitoring in an integrated sensing and communication scenario.

Optionally, the first signal in this embodiment of this application may be a signal that does not include transmission information, such as an LTE/NR synchronization and reference signal in a related technology, including a synchronization signal and PBCH block (SSB) signal, a channel state information-reference signal (CSI-RS), a demodulation reference signal (DMRS), a sounding reference signal (SRS), a positioning reference signal (PRS), a phase tracking reference signal (PTRS), or the like; or may be a single-frequency continuous wave (CW), a frequency modulated continuous wave (Frequency Modulated CW, FMCW), and ultra-wideband Gaussian pulses commonly used by radar; or may be a newly designed dedicated signal with a good correlation characteristic and a low peak-to-average power ratio, or a newly designed integrated sensing and communication signal that carries specific information and has better sensing performance. For example, the new signal is obtained by splicing/combining/superposing at least one dedicated sensing signal/reference signal and at least one communication signal in time domain and/or frequency domain. The second signal is similar in form to the first signal. Details are not described herein again.

Optionally, in another embodiment of this application, the sensing link performance includes at least one of the following:
A101. A power value of a sensing target association signal component.

For example, the power value may be a power value of a sensing path.

It should be noted that the power value of the sensing target association signal component is a signal component power that is greatly affected by a sensing target in the received first signal, and may be at least one of the following:
A1011. A power value calculated by using an amplitude corresponding to a sample point with a largest amplitude in a frequency domain channel response of the received first signal as a target amplitude, a power value calculated by using an amplitude corresponding to multiple sample points with a largest amplitude as a target amplitude, a power value calculated by using an amplitude of a sample point corresponding to a specified subcarrier or physical resource block (PRB) as a target amplitude, or a power value calculated by using an amplitude of sample points corresponding to multiple specified subcarriers or PRBs as a target amplitude.
A1012. A power value calculated by using an amplitude corresponding to a sample point with a largest amplitude in an inverse Fourier transform (IFFT) result (delay domain) of a frequency domain channel response of the received first signal as a target amplitude, a power value calculated by using an amplitude corresponding to multiple sample points with a largest amplitude as a target amplitude,
a power value calculated by using an amplitude corresponding to a sample point with a largest amplitude within a specific delay range as a target amplitude, or a power value calculated by using an amplitude corresponding to multiple sample points with a largest amplitude as a target amplitude.
A1013. A power value calculated by using an amplitude corresponding to a sample point with a largest amplitude in a Fourier transform (FFT) result (Doppler domain) of a time domain channel response of the received first signal as a target amplitude, a power value calculated by using an amplitude corresponding to multiple sample points with a largest amplitude as a target amplitude,
a power value calculated by using an amplitude corresponding to a sample point with a largest amplitude within a specific Doppler range, or a power value calculated by using an amplitude corresponding to multiple sample points with a largest amplitude as a target amplitude.
A1014. A power value calculated by using an amplitude corresponding to a sample point with a largest amplitude in a two-dimensional Fourier transform result, that is, a delay-Doppler domain result of a channel response of the received first signal as a target amplitude, a power value calculated by using an amplitude corresponding to multiple sample points with a largest amplitude as a target amplitude,
a power value calculated by using an amplitude corresponding to a sample point with a largest amplitude within a specific delay-Doppler range as a target amplitude, or a power value calculated by using an amplitude corresponding to multiple sample points with a largest amplitude as a target amplitude.

It should be noted that the largest amplitude may alternatively mean that an amplitude exceeds a specific threshold, where the specific threshold may be indicated by a network side device, or may be calculated by the terminal according to a noise power and/or an interference power.

The specific delay/Doppler range is related to a sensing requirement, and may be indicated by the network side device, or may be obtained by the terminal according to the sensing requirement.

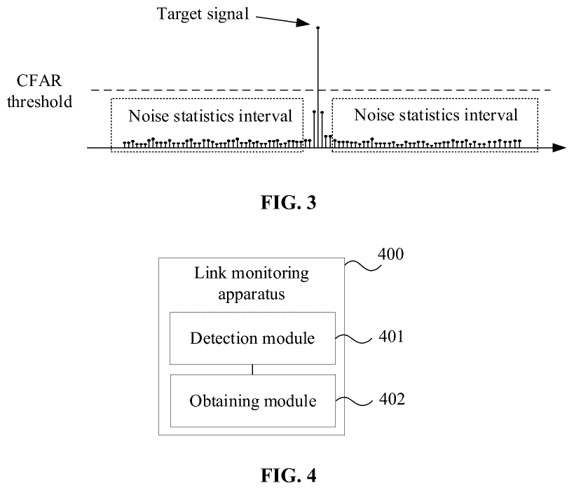

Radar detection is used as an example. The power value of the sensing target association signal component is an echo power, and a method for obtaining an echo signal power may be at least one of the following options:
B11. Perform constant false alarm detection (CFAR) based on a one-dimensional delay graph obtained by performing fast time-dimensional FFT processing on an echo signal, where a sample point with a largest amplitude among sample points whose CFAR exceeds a threshold is used as a target sample point and the amplitude of the sample point with the largest amplitude is used as a target signal amplitude, as shown in FIG. 3.
B12. Perform a CFAR based on a one-dimensional Doppler graph obtained by performing slow time-dimensional FFT processing on an echo signal, where a sample point with a largest amplitude among sample points whose CFAR exceeds a threshold is used as a target sample point and the amplitude of the sample point with the largest amplitude is used as a target signal amplitude, as shown in FIG. 3.
B13. Perform a CFAR based on a two-dimensional delay-Doppler graph obtained by performing two-dimensional (2D)-FFT processing on an echo signal, where a sample point with a largest amplitude among sample points whose CFAR exceeds a threshold is used as a target sample point and the amplitude of the sample point with the largest amplitude is used as a target signal amplitude.

B14. Perform a CFAR based on a three-dimensional delay-Doppler-angle graph obtained by performing 3D-FFT processing on an echo signal, where a sample point with a largest amplitude among sample points whose CFAR exceeds a threshold is used as a target sample point and the amplitude of the sample point with the largest amplitude is used as a target signal amplitude.

It should be noted that, in addition to a method for determining the target signal amplitude by using the sample point with the largest amplitude among the sample points whose CFAR exceeds the threshold as the target sample point, an average value of the sample point with the largest amplitude among the sample points whose CFAR exceeds the threshold and several sample points exceeding the threshold that are nearest to the sample point with the largest amplitude may be used as the target signal amplitude.
A102. A sensing signal-to-noise ratio (SNR).

For example, the sensing SNR may be a ratio of the power value of the sensing target association signal component to a noise power.
A103. A sensing signal to interference plus noise ratio (SINR).

For example, the sensing SINR may be a ratio of the power value of the sensing target association signal component to a sum of a noise power and an interference power.

Specifically, a method for obtaining the SNR/SINR may be as follows:
B21. Perform constant false alarm detection (CFAR) based on a one-dimensional delay graph obtained by performing fast time-dimensional FFT processing on an echo signal, where a sample point with a largest amplitude among sample points whose CFAR exceeds a threshold is used as a target sample point, the amplitude of the sample point with the largest amplitude is used as a target signal amplitude, all sample points except ±ε sample points separated from the target sample point in the one-dimensional graph are used as interference/noise sample points, an average interference/amplitude is counted as an interference/noise signal amplitude, as shown in FIG. 3, and finally, the SNR/SINR is calculated by using the target signal amplitude and the interference/noise signal amplitude.
B22. Perform a CFAR based on a one-dimensional Doppler graph obtained by performing slow time-dimensional FFT processing on an echo signal, where a sample point with a largest amplitude among sample points whose CFAR exceeds a threshold is used as a target sample point, the amplitude of the sample point with the largest amplitude is used as a target signal amplitude, all sample points except ±η sample points separated from the target sample point in the one-dimensional graph are used as interference/noise sample points, an average amplitude is counted as an interference/noise signal amplitude, and finally, the SNR/SINR is calculated by using the target signal amplitude and the interference/noise signal amplitude.
B23. Perform a CFAR based on a two-dimensional delay-Doppler graph obtained by performing 2D-FFT processing on an echo signal, where a sample point with a largest amplitude among sample points whose CFAR exceeds a threshold is used as a target sample point, the amplitude of the sample point with the largest amplitude is used as a target signal amplitude, all sample points except IF (fast time-dimensional) and ±η (slow time-dimensional) sample points separated from the target sample point in the two-dimensional graph are used as interference/noise sample points, an average amplitude is counted as an interference/noise signal amplitude, and finally, the SNR/SINR is calculated by using the target signal amplitude and the interference/noise signal amplitude.
B24. Perform a CFAR based on a three-dimensional delay-Doppler-angle graph obtained by performing 3D-FFT processing on an echo signal, where a sample point with a largest amplitude among sample points whose CFAR exceeds a threshold is used as a target sample point, the amplitude of the sample point with the largest amplitude is used as a target signal amplitude, all sample points except ±ε (fast time-dimensional), ±η (slow time-dimensional), and ±δ (angle-dimensional) sample points separated from the target sample point in the three-dimensional graph are used as interference/noise sample points, an average amplitude is counted as an interference/noise signal amplitude, and finally, the SNR/SINR is calculated by using the target signal amplitude and the interference/noise signal amplitude.

It should be noted that, in addition to a manner for determining the target signal amplitude by using the sample point with the largest amplitude among the sample points whose CFAR exceeds the threshold as the target sample point, an average value of the sample point with the largest amplitude among the sample points whose CFAR exceeds the threshold and several sample points exceeding the threshold that are nearest to the sample point with the largest amplitude may be used as the target signal amplitude.

It should be noted that a manner for determining an interference/noise sample point may alternatively be to perform further screening according to the foregoing determined interference/noise sample points, where a screening manner is as follows: For the one-dimensional delay graph, several sample points near a delay of 0 are removed, and a remaining interference/noise sample point is used as the noise sample point. For the one-dimensional Doppler graph, several sample points near Doppler being 0 are removed, and a remaining interference/noise sample point is used as the interference/noise sample point. For the two-dimensional delay-Doppler graph, several points near a delay of 0 and interference/noise sample points within a strip range formed by all Doppler ranges are removed, and a remaining noise sample point is used as the interference/noise sample point. For the three-dimensional delay-Doppler-angle graph, several points near a delay of 0 and interference/noise sample points within a slice range formed by all Doppler ranges and all angle ranges are removed, and a remaining interference/noise sample point is used as the interference/noise sample point.
A104. Whether a sensing target exists.

This may include at least one of the following:
whether a sensing target within a speed or Doppler preset range exists; or whether a sensing target within a distance or delay preset range exists.
A105. A target quantity of sensing targets.

This may include at least one of the following:
a target quantity of sensing targets within the speed or Doppler preset range; or
a target quantity of sensing targets within the distance or delay preset range.

It should be noted that the A104 and A105 mentioned above may be notified to the terminal by another device (for example, another terminal, an access network device, or a core network device) according to a sensing requirement.

It should be noted that a manner for determining whether the sensing target exists may be: for example, whether a sample point whose amplitude exceeds a specific threshold exists in the one-dimensional or two-dimensional delay/Doppler graph. In a case that the sample point exists, it is considered that the sensing target is detected, and a quantity of sample points whose amplitude exceeds the specific threshold in the one-dimensional or two-dimensional delay/Doppler graph is considered as a quantity of sensing targets.
A106. Radar cross-section (RCS) information of a sensing target.

It should be noted that the RCS information may be RCS information of a single sensing target, or may be RCS information of multiple sensing targets.
A107. Spectral information of a sensing target.

It should be noted that the spectrum information may include at least one of the following: a delay power spectrum, a Doppler power spectrum, a delay/distance-Doppler/speed spectrum, an angle power spectrum, a delay/distance-angle spectrum, a Doppler/speed-angle spectrum, or a delay/distance-Doppler/speed-angle spectrum.
A108. A delay of at least one sensing target.
A109. A distance of at least one sensing target.
A110. Doppler of at least one sensing target.
A111. A speed of at least one sensing target.
A112. Angle information of at least one sensing target.

Optionally, the communication link performance includes at least one of the following:
a reference signal received power (RSRP), a received signal strength indication (RSSI), a precoding matrix indicator (PMI), a rank indicator (RI), a channel quality indicator (CQI), a SNR, a SINR, a bit error rate (BER), or a block error rate (BLER).

Optionally, in another embodiment of this application, a specific implementation in which the terminal performs the measurement based on the target signal, and obtains the link performance corresponding to the target signal is:

The terminal performs one measurement on at least one target signal with a first periodicity through a physical layer, and obtains the link performance corresponding to the target signal.

It should be noted that, optionally, the target signal is configured by the network side device (such as a base station) to the terminal, that is, a specific implementation in which the terminal measures the target signal configured by the network side device is: The terminal performs, at the interval of the first period through the physical layer, one measurement on the at least one target signal configured by the network side device.

It should be noted that the terminal measures the signal based on the first signal and parameter configuration information for the first signal and the second signal. The parameter configuration information is configured by the network side device for the terminal.

It should be noted that parameter configuration information for different signals includes at least one of the following:
C101. a waveform type, for example, orthogonal frequency division multiplexing (OFDM), single-carrier frequency-division multiple access (SC-FDMA), orthogonal time frequency space (OTFS), a frequency modulated continuous wave (FMCW), or a pulse signal;
C102. a subcarrier spacing, for example, a subcarrier spacing 30 KHz of an OFDM system;
C103. a guard interval: a time interval between a moment at which sending of a signal ends and a moment at which a latest echo signal of the signal is received; this parameter is proportional to a maximum sensing distance; for example, the guard interval may be calculated through 2dₘₐₓ/c, where dₘₐₓ represents the maximum sensing distance (which belongs to a sensing requirement); for example, for a target signal sent and received by itself, dₘₐₓ represents a maximum distance between a receiving point of the target signal and a signal transmission point; and in some cases, a cyclic prefix CP of an OFDM signal may serve as a minimum guard interval;
C104. a bandwidth: this parameter is inversely proportional to distance resolution, and may be obtained by using c/(2Δd) where Δd is the distance resolution (which belongs to a sensing requirement), and c is a speed of light;
C105. burst duration: this parameter is inversely proportional to rate resolution (which belongs to a sensing requirement), and the parameter is a time span of the target signal and is mainly used to calculate a Doppler frequency shift; and the parameter may be calculated by using c/(2f_{c}Δv), where Δv is speed resolution, and f_{c} is a carrier frequency of the target signal;
C106. a time domain interval: this parameter may be calculated by using c (2f_{c}v_{range}) where v_{range} is a maximum rate minus a minimum speed (which belongs to a sensing requirement), and the parameter is a time interval between two adjacent target signals;
C107. a sending signal power, for example, a value taken every 2 dBm from −20 dBm to 23 dBm;
C108. a signal format, for example, a sounding reference signal (SRS), a demodulation reference signal (DMRS), a positioning reference signal (PRS), or the like, or another predefined signal, a related sequence format, and other information;
C109. a signal direction, for example, direction or beam information of the target signal;
C110. a time resource, for example, an index of a slot in which the target signal is located or a symbol index of the slot, where the time resource is classified into two types, one is a one-time time resource, for example, an omnidirectional target signal is sent on a symbol, and the other is a non-one-time time resource, for example, multiple groups of periodic time resources or discontinuous time resources (which may include start time and end time), each group of periodic time resources is used to send target signals in a same direction, and beam directions on different groups of periodic time resources are different;
C111. a frequency resource, including a center frequency, a bandwidth, an RB or a subcarrier, a point A, a start bandwidth position, or the like of the target signal;
C112. a quasi co-location (QCL) relationship, for example, the target signal includes multiple resources and each resource is QCLed to one SSB, where the QCL includes Type A, B, C, or D; or
C113. antenna configuration information for a sensing node (a base station or a user terminal (User Equipment, UE)).

The antenna configuration information for the sensing node (the base station or the UE) includes at least one of the following:
C1131. an antenna array element identifier (Identity, ID) or an antenna port ID used to send and/or receive the target signal;
C1132. a panel ID+an array element ID used to send and/or receive the target signal;
C1133. position information of an antenna array element used to send and/or receive the target signal relative to a local reference point on an antenna array (which may be represented by Cartesian coordinates (x, y, z) or spherical coordinates (ρ, φ, θ));
C1134. position information of a panel used to send and/or receive the target signal relative to a local reference point on an antenna array (which may be represented by Cartesian coordinates (x, y, z) or spherical coordinates (β, φ, θ)), and position information of an antenna array element used to send the target signal in these selected panels relative to a unified reference point of the panel (such as a center point of the panel) (which may be represented by Cartesian coordinates (x, y, z) or spherical coordinates (ρ, φ, θ));
C1135. bitmap information of an antenna array element; for example, the bitmap uses “1” to indicate that an array element is selected to send and/or receive the target signal, and uses “0” to indicate that an array element is not selected (or vice versa);
C1136. bitmap information of an array panel; for example, the bitmap uses “1” to indicate that a panel is selected to send and/or receive the target signal, and uses “0” to indicate that an array element is not selected (or vice versa); and there is bitmap information of an array element in these selected panels; or
C1137. threshold information, that is, a threshold used to determine whether an obtained measurement value of a sensing measurement quantity for at least one of a source node, a first device, or a candidate node meets the first condition; thresholds may be different for different candidate nodes and/or candidate tags, there may be more than one sensing measurement quantity and corresponding threshold for any candidate node and/or candidate tag, and the first condition is that a candidate node/candidate tag corresponding to an obtained measurement value of a sensing measurement quantity may be used as a target node/target tag.

Optionally, in another embodiment of this application, after the terminal performs the measurement based on the target signal, and obtains the link performance corresponding to the target signal, the method further includes at least one of the following:
D11. The terminal reports first information to a higher layer through a physical layer when a first case is met.

The first case includes one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition.

The first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition.
D12. The terminal reports second information to a higher layer through a physical layer when a second case is met.

The second case includes one of the following: the sensing link performance corresponding to the first signal does not meet the first condition; or the sensing link performance corresponding to the first signal does not meet the first condition and/or the communication link performance corresponding to the first signal does not meet the second condition.

The second information indicates that the sensing link performance corresponding to the first signal does not meet the first condition, or the sensing link performance corresponding to the first signal does not meet the first condition and/or the communication link performance corresponding to the first signal does not meet the second condition.
D13. The terminal reports target information to a higher layer through a physical layer when a third case is met.

The third case includes: the sensing link performance corresponding to the first signal does not meet the first condition and/or the communication link performance corresponding to the second signal does not meet the second condition.

The target information indicates that the sensing link performance corresponding to the first signal does not meet the first condition and/or the communication link performance corresponding to the second signal does not meet the second condition.

Optionally, that the terminal reports target information to a higher layer through a physical layer when a third case is met includes at least one of the following:
the terminal reports third information to the higher layer through the physical layer in a case that the sensing link performance corresponding to the first signal does not meet the first condition and the communication link performance corresponding to the second signal meets the second condition, where the third information indicates that the sensing link performance corresponding to the first signal does not meet the first condition and the communication link performance corresponding to the second signal meets the second condition;
the terminal reports fourth information to the higher layer through the physical layer in a case that the sensing link performance corresponding to the first signal meets the first condition and the communication link performance corresponding to the second signal does not meet the second condition, where the fourth information indicates that the sensing link performance corresponding to the first signal meets the first condition and the communication link performance corresponding to the second signal does not meet the second condition; or
the terminal reports fifth information to the higher layer through the physical layer in a case that the sensing link performance corresponding to the first signal does not meet the first condition and the communication link performance corresponding to the second signal does not meet the second condition, where the fifth information indicates that the sensing link performance corresponding to the first signal does not meet the first condition and the communication link performance corresponding to the second signal does not meet the second condition.

It can be learned from the foregoing description that reporting cases of the terminal include the following cases:
D21. The terminal reports the first information to the higher layer through the physical layer in a case that the sensing link performance corresponding to the first signal meets the first condition.

It should be noted that in this case, the first information indicates that the sensing link performance corresponding to the first signal meets the first condition.
D22. The terminal reports the second information to the higher layer through the physical layer in a case that the sensing link performance corresponding to the first signal does not meet the first condition.

It should be noted that in this case, the second information indicates that the sensing link performance corresponding to the first signal does not meet the first condition.
D23. The terminal reports the first information to the higher layer through the physical layer in a case that the sensing link performance corresponding to the first signal meets the first condition and the communication link performance corresponding to the first signal meets the second condition.

It should be noted that in this case, the first information indicates that the sensing link performance corresponding to the first signal meets the first condition and the communication link performance corresponding to the first signal meets the second condition.
D24. The terminal reports the second information to the higher layer through the physical layer in a case that the sensing link performance corresponding to the first signal does not meet the first condition and/or the communication link performance corresponding to the first signal does not meet the second condition.

It should be noted that in this case, the second information indicates that the sensing link performance corresponding to the first signal does not meet the first condition and/or the communication link performance corresponding to the first signal does not meet the second condition.
D25. The terminal reports the first information to the higher layer through the physical layer in a case that the sensing link performance corresponding to the first signal meets the first condition and the communication link performance corresponding to the second signal meets the second condition.

It should be noted that in this case, the first information indicates that the sensing link performance corresponding to the first signal meets the first condition and the communication link performance corresponding to the second signal meets the second condition.
D26. The terminal reports the target information to the higher layer through the physical layer in a case that the sensing link performance corresponding to the first signal does not meet the first condition and/or the communication link performance corresponding to the second signal does not meet the second condition.

It should be noted that in this case, the target information indicates that the sensing link performance corresponding to the first signal does not meet the first condition and/or the communication link performance corresponding to the second signal does not meet the second condition.

Optionally, in another embodiment of this application, an implementation in which the terminal reports the target information to the higher layer through the physical layer in the case that the sensing link performance corresponding to the first signal does not meet the first condition and/or the communication link performance corresponding to the second signal does not meet the second condition includes at least one of the following:
D261. The terminal reports third information to the higher layer through the physical layer in a case that the sensing link performance corresponding to the first signal does not meet the first condition and the communication link performance corresponding to the second signal meets the second condition, where the third information indicates that the sensing link performance corresponding to the first signal does not meet the first condition and the communication link performance corresponding to the second signal meets the second condition.
D262. The terminal reports fourth information to the higher layer through the physical layer in a case that the sensing link performance corresponding to the first signal meets the first condition and the communication link performance corresponding to the second signal does not meet the second condition, where the fourth information indicates that the sensing link performance corresponding to the first signal meets the first condition and the communication link performance corresponding to the second signal does not meet the second condition.
D263. The terminal reports fifth information to the higher layer through the physical layer in a case that the sensing link performance corresponding to the first signal does not meet the first condition and the communication link performance corresponding to the second signal does not meet the second condition, where the fifth information indicates that the sensing link performance corresponding to the first signal does not meet the first condition and the communication link performance corresponding to the second signal does not meet the second condition.

It should be noted herein that D21 and D22 are in one group, D23 and D24 are in one group, and D25 and D26 are in one group. During actual application, the terminal measures a signal in an information reporting manner corresponding to the measurement. For example, D21 and D22 are used when the terminal measures the first signal and obtains the sensing link performance. D23 and D24 are used when the terminal measures the first signal and obtains the sensing link performance and the communication link performance. D25 and D26 are used when the terminal measures the first signal and obtains the sensing link performance; and measures the second signal and obtains the communication link performance.

It should be noted herein that the first condition includes at least one of the following:
E11. A power value of a sensing target association signal component of one first signal meets a first threshold.
E12. A SNR of at least one first signal meets a second threshold.
E13. A SINR of at least one first signal meets a third threshold.
E14. At least Y sensing targets are detected.
Y is configured by the base station, and Y is a positive integer.

It should be noted that this case corresponds to a case of detecting multiple targets at the same time.
E15. A bitmap corresponding to a sensing target determined based on monitoring is consistent with a preset bitmap configured by the network side device.

For example, a position of each bit in the bitmap represents a target, a bit 1 indicates that the target is detected, and a bit 0 indicates that the target is not detected.

It should be noted that this case corresponds to a case of detecting multiple targets at the same time.
E16. An RCS of a sensing target meets a first preset condition.

It should be noted that the RCS may be RCS information of a single sensing target, or may be RCS information of multiple sensing targets.

For example, the first preset condition is that the RCS reaches K1 square meters, where K1 is a positive real number.
E17. Spectral information of a sensing target meets a second preset condition.

For example, a distance-speed spectrum of the sensing target meets the second preset condition, where the second preset condition herein is that the sensing target can be distinguished on the distance-speed spectrum (an amplitude of a point or a region on the distance-speed spectrum reaches a preset value); or a delay-Doppler spectrum of the sensing target meets the second preset condition, where the second preset condition herein is that the sensing target can be distinguished on the delay-Doppler spectrum (an amplitude of a point or a region on the delay-Doppler spectrum reaches a preset value).
E18. A first parameter of a sensing target meets a third preset condition, and the first parameter includes at least one of the following: a delay, a distance, Doppler, a speed, or angle information.

It should be noted that the first parameter may be a first parameter of a single sensing target, or may be first parameters of multiple sensing targets.

For example, the delay of the sensing target meets the third preset condition (for example, the delay meets an interval value). For another example, the distance of the sensing target meets the third preset condition (for example, the distance meets an interval value). For another example, the Doppler of the sensing target meets the third preset condition (for example, the Doppler meets an interval value). For another example, the speed of the sensing target meets the third preset condition (for example, the speed meets an interval value). For another example, the angle information of the sensing target meets the third preset condition (for example, the angle information meets an interval value).

Optionally, because the communication link performance includes at least one of parameters of an RSRP, an RSSI, a PMI, an RI, a CQI, a SNR, a SINR, a BER, a BLER, and the like, the second condition is a threshold corresponding to a specific parameter. For example, that the communication link performance does not meet the second condition may be that the RSRP is lower than a preset value such as −90 dBm, or that the SNR or the SINR is lower than a preset value such as 5 dB.

The following describes in detail specific implementation cases of the foregoing information reporting manners in different cases.

### 1. In a Case of D21 and D22

It should be noted that in this case, only the first signal is measured to obtain the sensing link performance corresponding to the first signal.

The terminal separately reports the first information or the second information to the higher layer (for example, an RRC layer) through the physical layer according to the sensing link performance obtained by measuring the first signal; starts a first timer in a case that a first specific condition is met; and determines a sensing link failure in a case that the first timer expires.

The first specific condition includes one of the following:
a quantity of second information continuously reported by the terminal to the higher layer through the physical layer is greater than or equal to a first threshold; or
a quantity of second information reported by the terminal to the higher layer through the physical layer is greater than or equal to a second threshold in continuous N1 measurements, where N1 is a positive integer.

Specifically, N1 is configured by the network side device, and timing duration of the first timer is also configured by the network side device.

Optionally, during running of the first timer, the first timer is stopped in a case that a second specific condition is met.

The second specific condition includes one of the following:
a quantity of first information continuously reported by the terminal to the higher layer through the physical layer is greater than or equal to a fourth threshold; or
a quantity of first information reported by the terminal to the higher layer through the physical layer is greater than or equal to a fifth threshold in continuous N2 measurements, where N2 is a positive integer.

Specifically, N2 is configured by the network side device.

After determining the sensing link failure, the terminal performs radio resource control RRC reestablishment; or the terminal reports measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

### 2. In a Case of D23 and D24

It should be noted that in this case, the first signal is measured to obtain the sensing link performance corresponding to the first signal and the communication link performance corresponding to the first signal.

The terminal separately reports the first information or the second information to the higher layer (for example, an RRC layer) through the physical layer according to the sensing link performance and the communication link performance obtained by measuring the first signal; starts a first timer in a case that a first specific condition is met; and determines a sensing link failure in a case that the first timer expires.

The first specific condition includes one of the following:
a quantity of second information continuously reported by the terminal to the higher layer through the physical layer is greater than or equal to a first threshold; or
a quantity of second information reported by the terminal to the higher layer through the physical layer is greater than or equal to a second threshold in continuous N1 measurements, where N1 is a positive integer.

Specifically, N1 is configured by the network side device, and timing duration of the first timer is also configured by the network side device.

Optionally, during running of the first timer, the first timer is stopped in a case that a second specific condition is met.

The second specific condition includes one of the following:
a quantity of first information continuously reported by the terminal to the higher layer through the physical layer is greater than or equal to a fourth threshold; or
a quantity of first information reported by the terminal to the higher layer through the physical layer is greater than or equal to a fifth threshold in continuous N2 measurements, where N2 is a positive integer.

Specifically, N2 is configured by the network side device.

After determining the sensing link failure, the terminal performs radio resource control RRC reestablishment; or the terminal reports measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

### 3. In a Case of D25 and D26

It should be noted that in this case, the first signal and the second signal are measured to obtain the sensing link performance corresponding to the first signal and the communication link performance corresponding to the second signal.

The terminal separately reports the first information or the target information to the higher layer (for example, an RRC layer) through the physical layer according to the sensing link performance obtained by measuring the first signal and the communication link performance obtained by measuring the second signal; starts a first timer in a case that a first specific condition is met; and determines a sensing link failure in a case that the first timer expires.

The first specific condition includes:
a quantity of target information continuously reported by the terminal to the higher layer through the physical layer is greater than or equal to a third threshold.

In general, the first specific condition means that a quantity of third information, fourth information, or fifth information continuously reported by the terminal to the higher layer through the physical layer is greater than or equal to the third threshold.

Optionally, during running of the first timer, the first timer is stopped in a case that a second specific condition is met.

The second specific condition includes:
a quantity of first information continuously reported by the terminal to the higher layer through the physical layer or a combined quantity of first information and target information continuously reported by the terminal to the higher layer through the physical layer is greater than or equal to a sixth threshold.

It should be noted that in this case, it may be understood as that a quantity of first information continuously reported by the terminal to the higher layer through the physical layer is greater than or equal to the sixth threshold; a combined quantity of first information and third information continuously reported by the terminal to the higher layer through the physical layer is greater than or equal to the sixth threshold; a combined quantity of first information and fourth information continuously reported by the terminal to the higher layer through the physical layer is greater than or equal to the sixth threshold; a combined quantity of first information and fifth information continuously reported by the terminal to the higher layer through the physical layer is greater than or equal to the sixth threshold; a combined quantity of first information, third information, and fourth information continuously reported by the terminal to the higher layer through the physical layer is greater than or equal to the sixth threshold; a combined quantity of first information, third information, and fifth information continuously reported by the terminal to the higher layer through the physical layer is greater than or equal to the sixth threshold; a combined quantity of first information, fourth information, and fifth information continuously reported by the terminal to the higher layer through the physical layer is greater than or equal to the sixth threshold; or a combined quantity of first information, third information, fourth information, and fifth information continuously reported by the terminal to the higher layer through the physical layer is greater than or equal to the sixth threshold.

After determining the sensing link failure, the terminal performs radio resource control RRC reestablishment, for example, the terminal sends a random access preamble to a network side; or the terminal reports measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

Optionally, in another embodiment of this application, after step 201, the method further includes:
sending a first message to a network side device in a case that sensing link performance corresponding to the first signal does not meet a first condition, where the first message indicates an RRC connection release request; and
the first message carries first indication information, and the first indication information indicates an RRC connection release cause.

Optionally, the first message further includes a measurement result of the sensing link performance.

Optionally, the RRC connection release cause includes: the sensing link performance corresponding to the first signal does not meet the first condition.

It should be noted that in this case, an RRC connection release process is triggered when the sensing link performance does not meet a requirement. That is, when an RRC connection is released, the network side device is notified that the sensing link performance does not meet the requirement.

The embodiments of this application are described in detail below during actual application.

### Application Case 1: Sensing Link Monitoring Procedure

Sensing link monitoring procedure: Evaluate whether a signal meets sensing link performance. In a case that a quantity of times that the condition is not met reaches a preset quantity of times, RRC reestablishment is performed.

It should be noted that in this case, a communication link monitoring procedure and a sensing link monitoring procedure are performed independently. Parameters of the two procedures are configured independently. In a case that a timer in any procedure (for example, T1 (corresponding to the first timer) in the sensing link monitoring procedure or T310 in the communication link monitoring procedure) expires, the RRC layer declares a link failure, and UE performs RRC reestablishment.

The following processes are mainly included:
S21: A physical layer of UE performs, with a fixed periodicity (the periodicity is configured by a base station), one measurement on N (N≥1) first signals configured by the base station to evaluate sensing link performance, where parameter configuration information for the first signal is configured by the base station.
S22: In a case that the sensing link performance meets a first condition, the physical layer of the UE reports, to a higher layer (RRC layer), that the condition is met (that is, first information), and a target threshold is configured by the base station; or
in a case that the sensing link performance does not meet a first condition, the physical layer reports, to a higher layer, that the condition is not met (that is, second information).
S23: In a case that a quantity of second information continuously reported exceeds a threshold N1 (or a quantity of second information reported in continuous NO measurements exceeds a threshold N1, where N0>N1), start a first timer.
N1 is configured by the base station, and timing duration of the first timer is configured by the base station.
S24: In a case that during running of the first timer, a quantity of first information continuously reported reaches a specific threshold N2 (or a quantity of first information reported in continuous N3 measurements exceeds N2, where N3>N2), stop the first timer (an RRC connection is still maintained in this case).
N2 is configured by the base station.
S25: In a case that the first timer expires, the RRC layer declares a sensing link failure.
S26: The UE performs RRC reestablishment, or
the UE reports the sensing link failure, and/or a cause of the sensing link failure (that is, a cause of step S12), and/or a measurement value of the sensing link performance to the base station, so that the base station triggers switching.

### Application Case 2: First Case of Joint Monitoring of a Sensing Link and a Communication Link

Joint monitoring procedure of the sensing link and the communication link: Evaluate whether the first signal meets sensing link performance and communication link performance. In a case that the first signal does not meet the sensing link performance and the communication link performance and a preset quantity of times is reached, perform RRC reestablishment.

The following processes are mainly included:
S21: A physical layer of UE performs, with a fixed periodicity (the periodicity is configured by a base station), one measurement on a first signal configured by the base station to evaluate sensing link performance and communication link performance, where parameter configuration information for the first signal is configured by the base station.

The UE measures one or more first signals.
S22: The physical layer of the UE reports first information to a higher layer (RRC layer) in a case that sensing link performance of one or more first signals meets a first condition and communication link performance of the same first signal meets a second condition, or sensing link performance of one or more first signals meets a sensing condition and communication link performance of one or more other first signals meets a communication condition. Otherwise, second information is reported.

It should be noted that provided that one first signal meets the communication condition, it means that the communication link performance meets the communication condition.
S23: In a case that a quantity of second information continuously reported exceeds a threshold N1, start a first timer.
N1 is configured by the base station, and timing duration of the first timer is configured by the base station.
S24: In a case that during running of the first timer, a quantity of first information continuously reported reaches a specific threshold N2, stop the first timer (an RRC connection is still maintained in this case).
N2 is configured by the base station.
S25: In a case that a T1 timer expires, the RRC layer declares a link failure.
S26: The UE performs RRC reestablishment, or
the UE reports the link failure, and/or a cause of the link failure (that is, a cause of step S22), and/or a measurement value of the link performance to the base station, so that the base station triggers switching.

### Application Case 3: Second Case of Joint Monitoring of a Sensing Link and a Communication Link

Joint monitoring procedure of the sensing link and the communication link (a total of four states): Evaluate whether a signal meets sensing link performance and communication link performance. In a case that the signal does not meet the sensing link performance and the communication link performance or does not meet any one of the sensing link performance and the communication link performance, and a preset quantity of times is reached, perform RRC reestablishment.

The following processes are mainly included:
S31: A physical layer of UE performs, with a fixed periodicity (the periodicity is configured by a base station), one measurement on a first signal configured by the base station to evaluate sensing link performance.

Optionally, the UE further measures a second signal configured by the base station to evaluate communication link performance. Parameter configuration information for the first signal and the second signal is configured by the base station.

It should be noted that the first signal and the second signal may be a same signal or different signals, or the first signal and the second signal are a same signal in different time domains or different frequency domains or different code domains (that is, respectively corresponding to two cases: communication link performance evaluation and sensing link performance evaluation share one reference signal, and communication link performance evaluation and sensing link performance evaluation use different reference signals respectively).
S32: The physical layer of the UE reports first information to a higher layer (RRC layer) in a case that sensing link performance of one or more first signals meets a first condition and communication link performance of the second signal meets a second condition, where
provided that one second signal meets the second condition, it means that the communication link performance meets a communication condition;
the physical layer of the UE reports third information to the higher layer (RRC layer) in a case that the sensing link performance of the first signal does not meet the first condition and the communication link performance of the second signal meets the second condition;
the physical layer of the UE reports fourth information to the higher layer (RRC layer) in a case that the sensing link performance of the first signal meets a sensing condition and the communication link performance of the second signal does not meet the second condition; and
the physical layer of the UE reports fifth information to the higher layer (RRC layer) in a case that the sensing link performance of the first signal does not meet the first condition and the communication link performance of the second signal does not meet the second condition.
S33: In a case that a quantity of fifth information, fourth information, or third information continuously reported exceeds a threshold N1, start a first timer.
N1 is configured by the base station, and timing duration of the first timer is configured by the base station.
S34: In a case that during running of the first timer, a quantity of first information (a sum of a quantity of first information and a combined quantity of at least one of third information, fourth information, or fifth information) continuously reported reaches a specific threshold N2, stop the first timer (an RRC connection is still maintained in this case).
N2 is configured by the base station.
S35: In a case that a T1 timer expires, the RRC layer declares a link failure.
S36: The UE performs RRC reestablishment, or
the UE reports the link failure, and/or a cause of the link failure (that is, a cause of step S32 and information about states A, B, C, and D), and/or a measurement value of the link performance to the base station, so that the base station triggers switching.
   Application Case 4: UE Triggers RRC Connection Release, and a Trigger Cause May be that “Sensing Performance does not Meet a Requirement”.

The following processes are mainly included:
S41: UE sends a first message to a base station, where the first message indicates an RRC connection release request.
S42: The first message may further carry a release assistance indication identifier (for example, a cause of RRC connection release), where the cause of the RRC connection release includes that sensing link performance obtained by the UE by measuring the first signal does not meet a first condition.

In addition, the cause of the RRC release further includes changes in a position, a speed, a panel, a battery level, an orientation, and the like of the UE.

The first message may further include a measurement result of the sensing link performance.

It should be noted that before S41, the UE needs to measure the first signal to obtain the corresponding sensing link performance.

Optionally, the sensing measurement quantity in the embodiments of this application includes at least one of the following:
Q11. A first-level measurement quantity, where the first-level measurement quantity includes at least one of the following: a result of an operation on I channels of data and Q channels of data of a frequency domain channel response of a receiving object (that is, a result of an operation on I channels of data and Q channels of data), a result of the frequency domain channel response of the receiving object (for example, the result of the frequency domain channel response may be obtained through channel estimation, and usually, the result of the frequency domain channel response is in a plural form), an amplitude of the frequency domain channel response of the receiving object, a phase of the frequency domain channel response of the receiving object, the I channels of data of the frequency domain channel response of the receiving object, or the Q channels of data of the frequency domain channel response of the receiving object, where the receiving object includes a received signal or a receiving channel.

Optionally, the foregoing operation may include an addition, subtraction, multiplication, division, a matrix addition/subtraction/multiplication, a matrix transposition, a triangular relationship operation, a square root operation, a power operation, and a threshold detection result and a maximum/minimum value extraction result of the operation result. The operation further includes fast Fourier transform (FFT)/inverse fast Fourier transform (IFFT), discrete Fourier transform (DFT)/inverse discrete Fourier transform (IDFT), 2D-FFT, 3D-FFT, matched filtering, autocorrelation calculation, wavelet transform, digital filtering, a threshold detection result of the foregoing operation result, a maximum/minimum value extraction result, and the like.

For example, the result of the operation on the I channels of data and the Q channels of data may be determined and obtained according to I×cos(theta)+Q×sin(theta), where theta is an angle value, I represents the I channels of data, and Q represents the Q channels of data.
Q12. A second-level measurement quantity, where the second-level measurement quantity includes at least one of the following: a delay, Doppler, an angle, or a signal strength.

The second-level measurement quantity may be considered as a basic measurement quantity.
Q13. A third-level measurement quantity, where the third-level measurement quantity includes at least one of the following: a distance of a sensing target, a speed of the sensing target, an orientation of the sensing target, a spatial position of the sensing target, or acceleration of the sensing target.

The third-level measurement quantity may be considered as a basic attribute/state of the sensing target.
Q14. A fourth-level measurement quantity (advanced attribute/state), including: whether a target exists, a trajectory, an action, an expression, a vital sign, a quantity, an imaging result, weather, air quality, a shape, a material, and composition.

Optionally, the sensing measurement quantity may further include corresponding tag information, where the tag information includes at least one of the following:
Q301. sensing signal identification information;
Q302. sensing measurement configuration identification information;
Q303. sensing service information (for example, a sensing service ID);
Q304. data subscription ID;
Q305. measurement quantity usage (communication, sensing, and communication and sensing);
Q306. time information;
Q307. sensing node information (for example, a UE ID, a node position, and a device orientation);
Q308. sensing link information (for example, a sensing link sequence number and a transceiver node ID);
Q309. measurement quantity description information (in a form such as an amplitude, a phase, a complex number, resource information such as an antenna/antenna pair/antenna group, a PRB, and a symbol); or
Q310. measurement quantity indicator information (for example, a SNR and a sensing SNR).

Optionally, the sensing result mentioned in the embodiments of this application includes at least one of the following:
a shape of the sensing target, an outline of the sensing target, whether the sensing target exists, a trajectory of the sensing target, an action of the sensing target, an expression of the sensing target, a vital sign of the sensing target, a quantity of sensing targets, an imaging result of the sensing target, weather, air quality, a material of the sensing target, composition of the sensing target, a gesture of the sensing target, a respiratory rate of the sensing target, heartbeat frequency of the sensing target, or sleep quality of the sensing target.

To sum up, the embodiments of this application provide the sensing link monitoring procedure and the joint sensing and communication link monitoring procedure, so that it can be found in time that sensing performance of a link does not meet a requirement, to find a new link to meet the sensing requirement.

The link monitoring method provided in the embodiments of this application may be performed by a link monitoring apparatus. In the embodiments of this application, the link monitoring apparatus provided in the embodiments of this application is described by using an example in which the link monitoring apparatus performs the link monitoring method.

As shown in FIG. 4, an embodiment of this application provides a link monitoring apparatus 400, applied to a terminal and including:
a detection module 401, configured to detect a target signal; and
an obtaining module, configured to perform a measurement based on the target signal, and obtain link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

Optionally, the detection module 401 is configured to:
perform one measurement on at least one target signal with a first periodicity through a physical layer, and obtain the link performance corresponding to the target signal.

Optionally, after the obtaining module performs the measurement based on the target signal, and obtains the link performance corresponding to the target signal, the apparatus further includes at least one of the following:
a first reporting module, configured to report first information to a higher layer through a physical layer when a first case is met;
a second reporting module, configured to report second information to a higher layer through a physical layer when a second case is met; or
a third reporting module, configured to report target information to a higher layer through a physical layer when a third case is met.

The first case includes one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition.

The first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition.

The second case includes one of the following: the sensing link performance corresponding to the first signal does not meet the first condition; or the sensing link performance corresponding to the first signal does not meet the first condition and/or the communication link performance corresponding to the first signal does not meet the second condition.

The second information indicates that the sensing link performance corresponding to the first signal does not meet the first condition, or the sensing link performance corresponding to the first signal does not meet the first condition and/or the communication link performance corresponding to the first signal does not meet the second condition.

The third case includes: the sensing link performance corresponding to the first signal does not meet the first condition and/or the communication link performance corresponding to the second signal does not meet the second condition.

The target information indicates that the sensing link performance corresponding to the first signal does not meet the first condition and/or the communication link performance corresponding to the second signal does not meet the second condition.

Optionally, the third reporting module is configured to implement at least one of the following:
report third information to the higher layer through the physical layer in a case that the sensing link performance corresponding to the first signal does not meet the first condition and the communication link performance corresponding to the second signal meets the second condition, where the third information indicates that the sensing link performance corresponding to the first signal does not meet the first condition and the communication link performance corresponding to the second signal meets the second condition;
report fourth information to the higher layer through the physical layer in a case that the sensing link performance corresponding to the first signal meets the first condition and the communication link performance corresponding to the second signal does not meet the second condition, where the fourth information indicates that the sensing link performance corresponding to the first signal meets the first condition and the communication link performance corresponding to the second signal does not meet the second condition; or
report fifth information to the higher layer through the physical layer in a case that the sensing link performance corresponding to the first signal does not meet the first condition and the communication link performance corresponding to the second signal does not meet the second condition, where the fifth information indicates that the sensing link performance corresponding to the first signal does not meet the first condition and the communication link performance corresponding to the second signal does not meet the second condition.

Optionally, the apparatus further includes:
a start module, configured to start a first timer in a case that a first specific condition is met; and
a determining module, configured to determine a sensing link failure in a case that the first timer expires.

The first specific condition includes at least one of the following:
a quantity of second information continuously reported by the terminal to the higher layer through the physical layer is greater than or equal to a first threshold;
a quantity of second information reported by the terminal to the higher layer through the physical layer is greater than or equal to a second threshold in continuous N1 measurements, where N1 is a positive integer; or
a quantity of target information continuously reported by the terminal to the higher layer through the physical layer is greater than or equal to a third threshold.

Optionally, the apparatus further includes:
a stop module, configured to: during running of the first timer, stop the first timer in a case that a second specific condition is met.

The second specific condition includes at least one of the following:
a quantity of first information continuously reported by the terminal to the higher layer through the physical layer is greater than or equal to a fourth threshold;
a quantity of first information reported by the terminal to the higher layer through the physical layer is greater than or equal to a fifth threshold in continuous N2 measurements, where N2 is a positive integer; or
a quantity of first information continuously reported by the terminal to the higher layer through the physical layer or a combined quantity of first information and target information continuously reported by the terminal to the higher layer through the physical layer is greater than or equal to a sixth threshold.

Optionally, after the determining module determines the sensing link failure, the apparatus further includes:
a reestablishment module, configured to perform radio resource control RRC reestablishment; and
a fourth reporting module, configured to report measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

Optionally, the apparatus further includes:
a sending module, configured to send a first message to a network side device in a case that sensing link performance corresponding to the first signal does not meet a first condition, where the first message indicates an RRC connection release request; and
the first message carries first indication information, and the first indication information indicates an RRC connection release cause.

Optionally, the first message further includes a measurement result of the sensing link performance.

Optionally, the RRC connection release cause includes: the sensing link performance corresponding to the first signal does not meet the first condition.

Optionally, the first condition includes at least one of the following:
a power value of a sensing target association signal component of at least one first signal meets a first threshold;
a sensing signal-to-noise ratio SNR of at least one first signal meets a second threshold;
a sensing signal to interference plus noise ratio SINR of at least one first signal meets a third threshold;
at least Y sensing targets are detected;
a bitmap corresponding to a sensing target determined based on monitoring is consistent with a preset bitmap configured by the network side device;
a radar cross-section RCS of a sensing target meets a first preset condition;
spectral information of a sensing target meets a second preset condition; or
a first parameter of a sensing target meets a third preset condition, and the first parameter includes at least one of the following: a delay, a distance, Doppler, a speed, or angle information, where
Y is a positive integer.

Optionally, the sensing link performance includes at least one of the following: a power value of a sensing target association signal component;
a sensing SNR;
a sensing SINR;
whether a sensing target exists;
a target quantity of sensing targets;
RCS information of a sensing target;
spectral information of a sensing target;
a delay of at least one sensing target;
a distance of at least one sensing target;
Doppler of at least one sensing target;
a speed of at least one sensing target; or
angle information of at least one sensing target.

Optionally, the communication link performance includes at least one of the following:
a reference signal received power RSRP, a received signal strength indication RSSI, a precoding matrix indicator PMI, a rank indicator RI, a channel quality indicator CQI, a SNR, a SINR, a bit error rate BER, or a block error rate BLER.

It should be noted that the apparatus embodiment is an apparatus corresponding to the foregoing method. All implementations in the foregoing method embodiment are applicable to the apparatus embodiment, and a same technical effect can be achieved. Details are not described herein again.

The link monitoring apparatus provided in this embodiment of this application can implement the processes of the method embodiment of FIG. 4, and a same technical effect can be achieved. To avoid repetition, details are not described herein again.

The link monitoring apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The link monitoring apparatus provided in this embodiment of this application can implement the processes of the method embodiment of FIG. 2, and a same technical effect can be achieved. To avoid repetition, details are not described herein again.

An embodiment of this application further provides a terminal, including a processor and a communication interface. The processor is configured to detect a target signal; and perform a measurement based on the target signal, and obtain link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

Optionally, the processor is configured to:
perform one measurement on at least one target signal with a first periodicity through a physical layer, and obtain the link performance corresponding to the target signal.

Optionally, the communication interface is further configured to implement at least one of the following:
report first information to a higher layer through a physical layer when a first case is met;
report second information to a higher layer through a physical layer when a second case is met; or
report target information to a higher layer through a physical layer when a third case is met.

The first case includes one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition.

The first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition.

The second case includes one of the following: the sensing link performance corresponding to the first signal does not meet the first condition; or the sensing link performance corresponding to the first signal does not meet the first condition and/or the communication link performance corresponding to the first signal does not meet the second condition.

The second information indicates that the sensing link performance corresponding to the first signal does not meet the first condition, or the sensing link performance corresponding to the first signal does not meet the first condition and/or the communication link performance corresponding to the first signal does not meet the second condition.

The third case includes: the sensing link performance corresponding to the first signal does not meet the first condition and/or the communication link performance corresponding to the second signal does not meet the second condition.

The target information indicates that the sensing link performance corresponding to the first signal does not meet the first condition and/or the communication link performance corresponding to the second signal does not meet the second condition.

Optionally, the communication interface is configured to implement at least one of the following:
report third information to the higher layer through the physical layer in a case that the sensing link performance corresponding to the first signal does not meet the first condition and the communication link performance corresponding to the second signal meets the second condition, where the third information indicates that the sensing link performance corresponding to the first signal does not meet the first condition and the communication link performance corresponding to the second signal meets the second condition;
report fourth information to the higher layer through the physical layer in a case that the sensing link performance corresponding to the first signal meets the first condition and the communication link performance corresponding to the second signal does not meet the second condition, where the fourth information indicates that the sensing link performance corresponding to the first signal meets the first condition and the communication link performance corresponding to the second signal does not meet the second condition; or
report fifth information to the higher layer through the physical layer in a case that the sensing link performance corresponding to the first signal does not meet the first condition and the communication link performance corresponding to the second signal does not meet the second condition, where the fifth information indicates that the sensing link performance corresponding to the first signal does not meet the first condition and the communication link performance corresponding to the second signal does not meet the second condition.

Optionally, the processor is further configured to:
start a first timer in a case that a first specific condition is met; and
determine a sensing link failure in a case that the first timer expires.

The first specific condition includes at least one of the following:
a quantity of second information continuously reported by the terminal to the higher layer through the physical layer is greater than or equal to a first threshold;
a quantity of second information reported by the terminal to the higher layer through the physical layer is greater than or equal to a second threshold in continuous N1 measurements, where N1 is a positive integer; or
a quantity of target information continuously reported by the terminal to the higher layer through the physical layer is greater than or equal to a third threshold.

Optionally, the processor is further configured to:
during running of the first timer, stop the first timer in a case that a second specific condition is met.

The second specific condition includes at least one of the following:
a quantity of first information continuously reported by the terminal to the higher layer through the physical layer is greater than or equal to a fourth threshold;
a quantity of first information reported by the terminal to the higher layer through the physical layer is greater than or equal to a fifth threshold in continuous N2 measurements, where N2 is a positive integer; or
a quantity of first information continuously reported by the terminal to the higher layer through the physical layer or a combined quantity of first information and target information continuously reported by the terminal to the higher layer through the physical layer is greater than or equal to a sixth threshold.

Optionally, the processor is further configured to:
perform radio resource control RRC reestablishment.

The communication interface is configured to report measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

Optionally, the communication interface is further configured to:
send a first message to a network side device in a case that sensing link performance corresponding to the first signal does not meet a first condition, where the first message indicates an RRC connection release request; and
the first message carries first indication information, and the first indication information indicates an RRC connection release cause.

Optionally, the first message further includes a measurement result of the sensing link performance.

Optionally, the RRC connection release cause includes: the sensing link performance corresponding to the first signal does not meet the first condition.

Optionally, the first condition includes at least one of the following:
a power value of a sensing target association signal component of at least one first signal meets a first threshold;
a sensing signal-to-noise ratio SNR of at least one first signal meets a second threshold;
a sensing signal to interference plus noise ratio SINR of at least one first signal meets a third threshold;
at least Y sensing targets are detected;
a bitmap corresponding to a sensing target determined based on monitoring is consistent with a preset bitmap configured by the network side device;
a radar cross-section RCS of a sensing target meets a first preset condition;
spectral information of a sensing target meets a second preset condition; or
a first parameter of a sensing target meets a third preset condition, and the first parameter includes at least one of the following: a delay, a distance, Doppler, a speed, or angle information, where
Y is a positive integer.

Optionally, the sensing link performance includes at least one of the following: a power value of a sensing target association signal component;
a sensing SNR;
a sensing SINR;
whether a sensing target exists;
a target quantity of sensing targets;
RCS information of a sensing target;
spectral information of a sensing target;
a delay of at least one sensing target;
a distance of at least one sensing target;
Doppler of at least one sensing target;
a speed of at least one sensing target; or
angle information of at least one sensing target.

Optionally, the communication link performance includes at least one of the following:
a reference signal received power RSRP, a received signal strength indication RSSI, a precoding matrix indicator PMI, a rank indicator RI, a channel quality indicator CQI, a SNR, a SINR, a bit error rate BER, or a block error rate BLER.

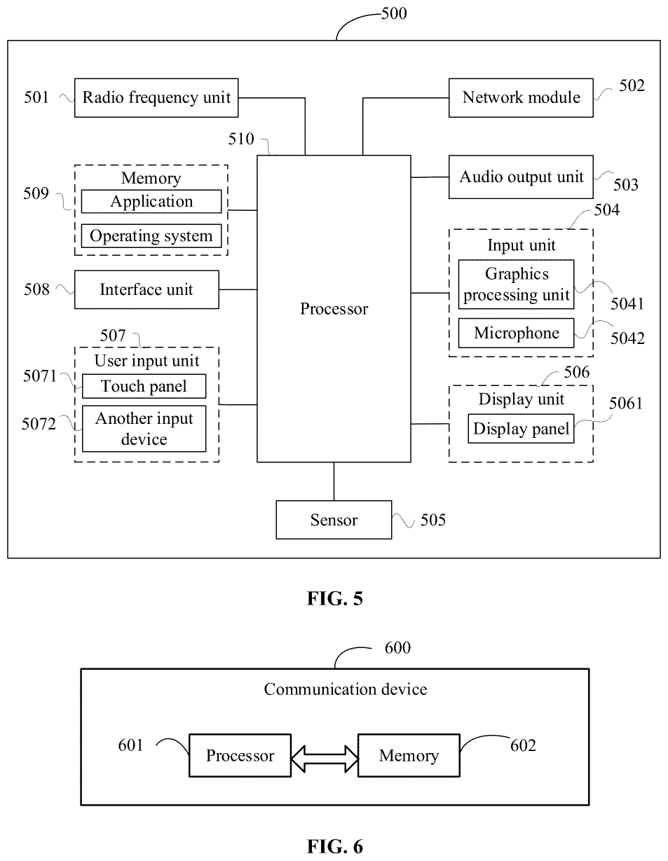

The terminal embodiment corresponds to the terminal side method embodiment, each implementation process and implementation of the method embodiment can be applied to the terminal embodiment, and a same technical effect can be achieved. Specifically, FIG. 5 is a schematic diagram of a hardware structure of a terminal according to an embodiment of this application.

The terminal 500 includes but is not limited to at least a part of components of a radio frequency unit 501, a network module 502, an audio output unit 503, an input unit 504, a sensor 505, a display unit 506, a user input unit 507, an interface unit 508, a memory 509, and a processor 510, and the like.

A person skilled in the art can understand that the terminal 500 may further include a power supply (such as a battery) that supplies power to each component. The power supply may be logically connected to the processor 510 by using a power supply management system, to implement functions such as charging and discharging management, and power consumption management by using the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a graphics processing unit (GPU) 5041 and a microphone 5042. The graphics processing unit 5041 processes image data of a static picture or a video obtained by an image capture apparatus (for example, a camera) in a video capture mode or an image capture mode. The display unit 506 may include a display panel 5061, and the display panel 5061 may be configured in a form of a liquid crystal display, an organic light-emitting diode, or the like. The user input unit 507 includes a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing; and sends uplink data to the network side device. Usually, the radio frequency unit 501 includes but is not limited to an antenna, at least one amplifier, a transceiver, a coupler, a low noise amplifier, a duplexer, and the like.

The memory 509 may be configured to store a software program or an instruction and various data. The memory 509 may mainly include a program or instruction storage area and a data storage area. The program or instruction storage area may store an operating system, an application or an instruction required by at least one function (for example, a sound playing function or an image playing function), and the like. In addition, the memory 509 may include a high-speed random access memory, and may further include a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory, for example, at least one disk storage device, a flash memory device, or another non-volatile solid-state storage device.

The processor 510 may include one or more processing units. Optionally, an application processor and a modem processor may be integrated into the processor 510. The application processor mainly processes an operating system, a user interface, an application, an instruction, or the like. The modem processor mainly processes wireless communication, for example, a baseband processor. It may be understood that, alternatively, the modem processor may not be integrated into the processor 510.

The processor 510 is configured to:
detect a target signal; and
perform a measurement based on the target signal, and obtain link performance corresponding to the target signal, where
the target signal includes a first signal, or the target signal includes a first signal and a second signal, and the first signal is a reference signal or a sensing signal; and
the link performance includes sensing link performance, or the link performance includes sensing link performance and communication link performance.

Optionally, the processor 510 is configured to:
perform one measurement on at least one target signal with a first periodicity through a physical layer, and obtain the link performance corresponding to the target signal.

Optionally, the radio frequency unit 501 is further configured to implement at least one of the following:
report first information to a higher layer through a physical layer when a first case is met;
report second information to a higher layer through a physical layer when a second case is met; or
report target information to a higher layer through a physical layer when a third case is met.

The first case includes one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition.

The first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition.

The second case includes one of the following: the sensing link performance corresponding to the first signal does not meet the first condition; or the sensing link performance corresponding to the first signal does not meet the first condition and/or the communication link performance corresponding to the first signal does not meet the second condition.

The second information indicates that the sensing link performance corresponding to the first signal does not meet the first condition, or the sensing link performance corresponding to the first signal does not meet the first condition and/or the communication link performance corresponding to the first signal does not meet the second condition.

The third case includes: the sensing link performance corresponding to the first signal does not meet the first condition and/or the communication link performance corresponding to the second signal does not meet the second condition.

The target information indicates that the sensing link performance corresponding to the first signal does not meet the first condition and/or the communication link performance corresponding to the second signal does not meet the second condition.

Optionally, the radio frequency unit 501 is configured to implement at least one of the following:
report third information to the higher layer through the physical layer in a case that the sensing link performance corresponding to the first signal does not meet the first condition and the communication link performance corresponding to the second signal meets the second condition, where the third information indicates that the sensing link performance corresponding to the first signal does not meet the first condition and the communication link performance corresponding to the second signal meets the second condition;
report fourth information to the higher layer through the physical layer in a case that the sensing link performance corresponding to the first signal meets the first condition and the communication link performance corresponding to the second signal does not meet the second condition, where the fourth information indicates that the sensing link performance corresponding to the first signal meets the first condition and the communication link performance corresponding to the second signal does not meet the second condition; or
report fifth information to the higher layer through the physical layer in a case that the sensing link performance corresponding to the first signal does not meet the first condition and the communication link performance corresponding to the second signal does not meet the second condition, where the fifth information indicates that the sensing link performance corresponding to the first signal does not meet the first condition and the communication link performance corresponding to the second signal does not meet the second condition.

Optionally, the processor 510 is further configured to:
start a first timer in a case that a first specific condition is met; and
determine a sensing link failure in a case that the first timer expires.

The first specific condition includes at least one of the following:
a quantity of second information continuously reported by the terminal to the higher layer through the physical layer is greater than or equal to a first threshold;
a quantity of second information reported by the terminal to the higher layer through the physical layer is greater than or equal to a second threshold in continuous N1 measurements, where N1 is a positive integer; or
a quantity of target information continuously reported by the terminal to the higher layer through the physical layer is greater than or equal to a third threshold.

Optionally, the processor 510 is further configured to:
during running of the first timer, stop the first timer in a case that a second specific condition is met.

The second specific condition includes at least one of the following:
a quantity of first information continuously reported by the terminal to the higher layer through the physical layer is greater than or equal to a fourth threshold;
a quantity of first information reported by the terminal to the higher layer through the physical layer is greater than or equal to a fifth threshold in continuous N2 measurements, where N2 is a positive integer; or
a quantity of first information continuously reported by the terminal to the higher layer through the physical layer or a combined quantity of first information and target information continuously reported by the terminal to the higher layer through the physical layer is greater than or equal to a sixth threshold.

Optionally, the processor 510 is further configured to:
perform radio resource control RRC reestablishment.

The communication interface is configured to report measurement-related information to a network side device, where the measurement-related information includes at least one of the following: the sensing link failure, a cause of the sensing link failure, a measurement value of sensing link performance, a communication link failure, a cause of a communication link failure, or a measurement value of communication link performance.

Optionally, the radio frequency unit 501 is further configured to:
send a first message to a network side device in a case that sensing link performance corresponding to the first signal does not meet a first condition, where the first message indicates an RRC connection release request; and
the first message carries first indication information, and the first indication information indicates an RRC connection release cause.

Optionally, the first message further includes a measurement result of the sensing link performance.

Optionally, the RRC connection release cause includes: the sensing link performance corresponding to the first signal does not meet the first condition.

Optionally, the first condition includes at least one of the following:
a power value of a sensing target association signal component of at least one first signal meets a first threshold;
a sensing signal-to-noise ratio SNR of at least one first signal meets a second threshold;
a sensing signal to interference plus noise ratio SINR of at least one first signal meets a third threshold;
at least Y sensing targets are detected;
a bitmap corresponding to a sensing target determined based on monitoring is consistent with a preset bitmap configured by the network side device;
a radar cross-section RCS of a sensing target meets a first preset condition;
spectral information of a sensing target meets a second preset condition; or
a first parameter of a sensing target meets a third preset condition, and the first parameter includes at least one of the following: a delay, a distance, Doppler, a speed, or angle information, where
Y is a positive integer.

Optionally, the sensing link performance includes at least one of the following:
a power value of a sensing target association signal component;
a sensing SNR;
a sensing SINR;
whether a sensing target exists;
a target quantity of sensing targets;
RCS information of a sensing target;
spectral information of a sensing target;
a delay of at least one sensing target;
a distance of at least one sensing target;
Doppler of at least one sensing target;
a speed of at least one sensing target; or
angle information of at least one sensing target.

Optionally, the communication link performance includes at least one of the following: a reference signal received power RSRP, a received signal strength indication RSSI, a precoding matrix indicator PMI, a rank indicator RI, a channel quality indicator CQI, a SNR, a SINR, a bit error rate BER, or a block error rate BLER.

In this embodiment of this application, the at least one first signal is measured to obtain at least the sensing link performance, so as to implement radio link monitoring in an integrated sensing and communication scenario.

An embodiment of this application further provides a readable storage medium. The readable storage medium stores a program or an instruction, and the program or the instruction is executed by a processor to implement the processes of the foregoing embodiment of the link monitoring method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

Optionally, as shown in FIG. 6, an embodiment of this application further provides a communication device 600, including a processor 601, a memory 602, and a program or an instruction stored in the memory 602 and executable on the processor 601. For example, when the communication device 600 is a terminal, the program or the instruction is executed by the processor 601 to implement the processes of the foregoing embodiment of the link monitoring method, and a same technical effect can be achieved. To avoid repetition, details are not described herein again.

An embodiment of this application further provides a chip. The chip includes a processor and a communication interface, the communication interface is coupled to the processor, and the processor is configured to run a program or an instruction to implement the processes of the foregoing embodiment of the link monitoring method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the link monitoring method, and a same technical effect can be achieved. To avoid repetition, details are not described herein again.

An embodiment of this application further provides a link monitoring system, including a terminal and a network side device. The terminal may be configured to perform the steps of the foregoing link monitoring method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A link monitoring method, comprising:
detecting, by a terminal, a target signal; and
performing, by the terminal, a measurement based on the target signal, and obtaining link performance corresponding to the target signal, wherein
the target signal comprises a first signal, or the target signal comprises a first signal and a second signal, and the first signal is a reference signal or a sensing signal; and
the link performance comprises sensing link performance, or the link performance comprises sensing link performance and communication link performance.

2. The method according to claim 1, wherein the performing, by the terminal, a measurement based on the target signal, and obtaining link performance corresponding to the target signal comprises:
performing, by the terminal, one measurement on at least one target signal with a first periodicity through a physical layer, and obtaining the link performance corresponding to the target signal.

3. The method according to claim 1, wherein after the performing, by the terminal, a measurement based on the target signal, and obtaining link performance corresponding to the target signal, the method further comprises at least one of the following:
reporting, by the terminal, first information to a higher layer through a physical layer when a first case is met;
reporting, by the terminal, second information to a higher layer through a physical layer when a second case is met; or
reporting, by the terminal, target information to a higher layer through a physical layer when a third case is met, wherein
the first case comprises one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition;
the first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition;
the second case comprises one of the following: the sensing link performance corresponding to the first signal does not meet the first condition; or the sensing link performance corresponding to the first signal does not meet the first condition and/or the communication link performance corresponding to the first signal does not meet the second condition;
the second information indicates that the sensing link performance corresponding to the first signal does not meet the first condition, or the sensing link performance corresponding to the first signal does not meet the first condition and/or the communication link performance corresponding to the first signal does not meet the second condition;
the third case comprises: the sensing link performance corresponding to the first signal does not meet the first condition and/or the communication link performance corresponding to the second signal does not meet the second condition; and
the target information indicates that the sensing link performance corresponding to the first signal does not meet the first condition and/or the communication link performance corresponding to the second signal does not meet the second condition.

4. The method according to claim 3, wherein the reporting, by the terminal, target information to a higher layer through a physical layer when a third case is met comprises at least one of the following:
reporting, by the terminal, third information to the higher layer through the physical layer in a case that the sensing link performance corresponding to the first signal does not meet the first condition and the communication link performance corresponding to the second signal meets the second condition, wherein the third information indicates that the sensing link performance corresponding to the first signal does not meet the first condition and the communication link performance corresponding to the second signal meets the second condition;
reporting, by the terminal, fourth information to the higher layer through the physical layer in a case that the sensing link performance corresponding to the first signal meets the first condition and the communication link performance corresponding to the second signal does not meet the second condition, wherein the fourth information indicates that the sensing link performance corresponding to the first signal meets the first condition and the communication link performance corresponding to the second signal does not meet the second condition; or
reporting, by the terminal, fifth information to the higher layer through the physical layer in a case that the sensing link performance corresponding to the first signal does not meet the first condition and the communication link performance corresponding to the second signal does not meet the second condition, wherein the fifth information indicates that the sensing link performance corresponding to the first signal does not meet the first condition and the communication link performance corresponding to the second signal does not meet the second condition.

5. The method according to claim 3, further comprising:
starting a first timer in a case that a first specific condition is met; and
determining a sensing link failure in a case that the first timer expires, wherein
the first specific condition comprises at least one of the following:
a quantity of second information continuously reported by the terminal to the higher layer through the physical layer is greater than or equal to a first threshold;
a quantity of second information reported by the terminal to the higher layer through the physical layer is greater than or equal to a second threshold in continuous N1 measurements, wherein N1 is a positive integer; or
a quantity of target information continuously reported by the terminal to the higher layer through the physical layer is greater than or equal to a third threshold.

6. The method according to claim 5, further comprising:
during running of the first timer, stopping the first timer in a case that a second specific condition is met, wherein
the second specific condition comprises at least one of the following:
a quantity of first information continuously reported by the terminal to the higher layer through the physical layer is greater than or equal to a fourth threshold;
a quantity of first information reported by the terminal to the higher layer through the physical layer is greater than or equal to a fifth threshold in continuous N2 measurements, wherein N2 is a positive integer; or
a quantity of first information continuously reported by the terminal to the higher layer through the physical layer or a combined quantity of first information and target information continuously reported by the terminal to the higher layer through the physical layer is greater than or equal to a sixth threshold.

7. The method according to claim 5, wherein after the determining a sensing link failure, the method further comprises one of the following:
performing radio resource control RRC reestablishment; or
reporting measurement-related information to a network side device, wherein the measurement-related information comprises at least one of the following: the sensing link failure, a cause of the sensing link failure, a measurement value of sensing link performance, a communication link failure, a cause of a communication link failure, or a measurement value of communication link performance.

8. The method according to claim 1, further comprising:
sending a first message to a network side device in a case that sensing link performance corresponding to the first signal does not meet a first condition, wherein the first message indicates an RRC connection release request; and
the first message carries first indication information, and the first indication information indicates an RRC connection release cause.

9. The method according to claim 8, wherein the first message further comprises a measurement result of the sensing link performance.

10. The method according to claim 8, wherein the RRC connection release cause comprises: the sensing link performance corresponding to the first signal does not meet the first condition.

11. The method according to claim 3, wherein the first condition comprises at least one of the following:
a power value of a sensing target association signal component of at least one first signal meets a first threshold;
a sensing signal-to-noise ratio SNR of at least one first signal meets a second threshold;
a sensing signal to interference plus noise ratio SINR of at least one first signal meets a third threshold;
at least Y sensing targets are detected;
a bitmap corresponding to a sensing target determined based on monitoring is consistent with a preset bitmap configured by the network side device;
a radar cross-section RCS of a sensing target meets a first preset condition;
spectral information of a sensing target meets a second preset condition; or
a first parameter of a sensing target meets a third preset condition, and the first parameter comprises at least one of the following: a delay, a distance, Doppler, a speed, or angle information, wherein
Y is a positive integer.

12. The method according to claim 1, wherein the sensing link performance comprises at least one of the following:
a power value of a sensing target association signal component;
a sensing SNR;
a sensing SINR;
whether a sensing target exists;
a target quantity of sensing targets;
RCS information of a sensing target;
spectral information of a sensing target;
a delay of at least one sensing target;
a distance of at least one sensing target;
Doppler of at least one sensing target;
a speed of at least one sensing target; or
angle information of at least one sensing target.

13. The method according to claim 1, wherein the communication link performance comprises at least one of the following:
a reference signal received power RSRP, a received signal strength indication RSSI, a precoding matrix indicator PMI, a rank indicator RI, a channel quality indicator CQI, a SNR, a SINR, a bit error rate BER, or a block error rate BLER.

14. Aterminal, comprising a processor and a memory, wherein the memory stores a program or an instruction that is executable on the processor, and the program or the instruction is executed by the processor to implement the following steps:
detecting a target signal; and
performing a measurement based on the target signal, and obtaining link performance corresponding to the target signal, wherein
the target signal comprises a first signal, or the target signal comprises a first signal and a second signal, and the first signal is a reference signal or a sensing signal; and
the link performance comprises sensing link performance, or the link performance comprises sensing link performance and communication link performance.

15. The terminal according to claim 14, wherein the performing the measurement based on the target signal, and obtaining link performance corresponding to the target signal comprises:
performing one measurement on at least one target signal with a first periodicity through a physical layer, and obtaining the link performance corresponding to the target signal.

16. The terminal according to claim 14, wherein after the performing the measurement based on the target signal, and obtaining link performance corresponding to the target signal, the program or the instruction is executed by the processor to implement:
reporting first information to a higher layer through a physical layer when a first case is met;
reporting second information to a higher layer through a physical layer when a second case is met; or
reporting target information to a higher layer through a physical layer when a third case is met, wherein
the first case comprises one of the following: sensing link performance corresponding to the first signal meets a first condition; sensing link performance corresponding to the first signal meets a first condition and communication link performance corresponding to the first signal meets a second condition; or sensing link performance corresponding to the first signal meets a first condition and communication link performance corresponding to the second signal meets a second condition;
the first information indicates that the sensing link performance corresponding to the first signal meets the first condition, the sensing link performance corresponding to the first signal meets the first condition and the communication link performance corresponding to the first signal meets the second condition, or the sensing link performance corresponding to the first signal meets the first condition and the communication link performance corresponding to the second signal meets the second condition;
the second case comprises one of the following: the sensing link performance corresponding to the first signal does not meet the first condition; or the sensing link performance corresponding to the first signal does not meet the first condition and/or the communication link performance corresponding to the first signal does not meet the second condition;
the second information indicates that the sensing link performance corresponding to the first signal does not meet the first condition, or the sensing link performance corresponding to the first signal does not meet the first condition and/or the communication link performance corresponding to the first signal does not meet the second condition;
the third case comprises: the sensing link performance corresponding to the first signal does not meet the first condition and/or the communication link performance corresponding to the second signal does not meet the second condition; and
the target information indicates that the sensing link performance corresponding to the first signal does not meet the first condition and/or the communication link performance corresponding to the second signal does not meet the second condition.

17. The terminal according to claim 16, wherein the reporting the target information to the higher layer through the physical layer when the third case is met comprises at least one of the following:
reporting third information to the higher layer through the physical layer in a case that the sensing link performance corresponding to the first signal does not meet the first condition and the communication link performance corresponding to the second signal meets the second condition, wherein the third information indicates that the sensing link performance corresponding to the first signal does not meet the first condition and the communication link performance corresponding to the second signal meets the second condition;
reporting fourth information to the higher layer through the physical layer in a case that the sensing link performance corresponding to the first signal meets the first condition and the communication link performance corresponding to the second signal does not meet the second condition, wherein the fourth information indicates that the sensing link performance corresponding to the first signal meets the first condition and the communication link performance corresponding to the second signal does not meet the second condition; or
reporting fifth information to the higher layer through the physical layer in a case that the sensing link performance corresponding to the first signal does not meet the first condition and the communication link performance corresponding to the second signal does not meet the second condition, wherein the fifth information indicates that the sensing link performance corresponding to the first signal does not meet the first condition and the communication link performance corresponding to the second signal does not meet the second condition.

18. The terminal according to claim 16, wherein the program or the instruction is executed by the processor to further implement:
starting a first timer in a case that a first specific condition is met; and
determining a sensing link failure in a case that the first timer expires, wherein
the first specific condition comprises at least one of the following:
a quantity of second information continuously reported by the terminal to the higher layer through the physical layer is greater than or equal to a first threshold;
a quantity of second information reported by the terminal to the higher layer through the physical layer is greater than or equal to a second threshold in continuous N1 measurements, wherein N1 is a positive integer; or
a quantity of target information continuously reported by the terminal to the higher layer through the physical layer is greater than or equal to a third threshold.

19. The terminal according to claim 18, wherein the program or the instruction is executed by the processor to further implement:
during running of the first timer, stopping the first timer in a case that a second specific condition is met, wherein
the second specific condition comprises at least one of the following:
a quantity of first information continuously reported by the terminal to the higher layer through the physical layer is greater than or equal to a fourth threshold;
a quantity of first information reported by the terminal to the higher layer through the physical layer is greater than or equal to a fifth threshold in continuous N2 measurements, wherein N2 is a positive integer; or
a quantity of first information continuously reported by the terminal to the higher layer through the physical layer or a combined quantity of first information and target information continuously reported by the terminal to the higher layer through the physical layer is greater than or equal to a sixth threshold.

20. A non-transitory readable storage medium, wherein the non-transitory readable storage medium stores a program or an instruction, and the program or the instruction is executed by a processor of a terminal to implement the following steps:
detecting a target signal; and
performing a measurement based on the target signal, and obtaining link performance corresponding to the target signal, wherein
the target signal comprises a first signal, or the target signal comprises a first signal and a second signal, and the first signal is a reference signal or a sensing signal; and
the link performance comprises sensing link performance, or the link performance comprises sensing link performance and communication link performance.
